(19) United States
(12) Patent Application Publication
(10) Pub. No.: US 2017/0230271 A1
(43) Pub. Date: Aug. 10, 2017

(54) DATA MANAGEMENT APPARATUS AND MONITORING METHOD OF SAME

(71) Applicant: Hitachi High-Technologies Corporation, Tokyo (JP)

(72) Inventors: Akira KAGOSHIMA, Tokyo (JP); Daisuke SHIRAISHI, Tokyo (JP); Yuji NAGATANI, Tokyo (JP)

(21) Appl. No.: 15/248,113

(22) Filed: Aug. 26, 2016

(30) Foreign Application Priority Data
Feb. 10, 2016 (JP) 2016-023230

(51) Int. Cl. H04L 12/26; H04L 29/08

(52) U.S. Cl. CPC H04L 43/14; H04L 67/10

(57) ABSTRACT

A data management apparatus according to an embodiment of the present invention includes a data analyzing unit that processes operation data transferred from a data collecting unit that collects the operation data of a semiconductor manufacturing apparatus, and a state monitoring unit that monitors a state of the data analyzing unit based on monitoring time. The monitoring time is the sum of first time that is time required for transferring the operation data to the data analyzing unit and second time that is time required for processing the operation data in the data analyzing unit.

### BACKGROUND OF THE INVENTION

The present invention relates to a data management apparatus that stores and manages data collected by a semiconductor manufacturing apparatus through a communication network, and a monitoring method of the data management apparatus.

As a process is complicated in a manufacturing apparatus using plasma, such as a semiconductor manufacturing apparatus, particularly, a dry etching apparatus or a chemical vapor deposition (CVD) apparatus, a problem of an unstable processing result due to, for example, trouble of the apparatus or the process, or aging, often occurs. In this case, for example, an apparatus engineer and a person in charge of production are required to take some types of measures in order to restore the apparatus or the process into a normal state.

In order to cope with the above circumstances, a semiconductor manufacturing apparatus collects and stores data of a process being processed. The semiconductor manufacturing apparatus performs data analysis with the data when the above problem occurs, and then attempts to solve the problem.

Typically, each manufacturing apparatus is coupled to a communication network. Collected data is stored in a data server (data management apparatus) on the network. For example, a person in charge of a semiconductor manufacturing line or an apparatus/process engineer accesses the above server so as to check and analyze the data. Therefore, collecting and storing the data from each manufacturing apparatus by the data server and stably, effectively using the data with no problem are included in one of important matters in production management. When, for example, a case where data is not present in the data server occurs, data analysis for a measure against apparatus trouble and for improvement of the apparatus trouble, cannot be performed. As a result, it is thought that an increase of mean time to recovery (MTTR) of an apparatus, degradation of an apparatus actual operation rate, or the like, occurs.

There is a technique described in JP-A-2008-118068 in order to achieve stable operation of a data server relating to semiconductor manufacturing. JP-A-2008-118068 describes the technique capable of monitoring a server coupled through a communication network with a log file of a CPU activity ratio, a hard disk activity ratio, or the like, and determining normality or abnormality.

As described above, the data server is required to continue stable operation. Techniques, such as an uninterruptible power supply (hereinafter, referred to as an UPS), a redundant array of inexpensive disks (hereinafter, referred to as a RAID) that improves redundancy of a hard disk, and the like, have been typically applied for hardware. A server OS, and resource monitoring of the server for a CPU load factor, memory usage, a hard disk activity ratio, and the like, have been applied for software.

Furthermore, for monitoring application software being executed in the server, there are a method of monitoring whether a process (task), as an executable unit, has started on the server OS and a method of monitoring, for example, the memory usage secured by the process.

### SUMMARY OF THE INVENTION

The technique described in JP-A-2008-118068 refers to a content of each log file in a plurality of servers and compares the content to a criterion content previously set by a user so as to determine whether an operating state of each of the servers is normal or abnormal. An object to be monitored in JP-A-2008-118068 is each of the log files. Each of the log files records a CPU activity ratio, a disk activity ratio, a memory activity ratio, a state of a system error in each of the servers. However, only the monitoring may be insufficient for state monitoring of the servers.

That is, when an application being executed in a server experiences unexpected operation, there is a case where no abnormality occurs in the above monitoring items. Examples of the case include a case where the application makes no response while having been executed, and a case where there is a potential problem with application logic from the first and a hangup occurs in the application.

Therefore, an object of the present invention is to provide a technique capable of monitoring a state in a case where an application in a server experiences unexpected behavior, in a data management apparatus by monitoring operation of the application from the outside in addition to monitoring of resources, such as a CPU activity ratio and a memory activity ratio, in a server.

A data management apparatus according to an embodiment of the present invention includes: a data analyzing unit configured to process operation data transferred from a data collecting unit that collects the operation data of a semiconductor manufacturing apparatus; and a state monitoring unit configured to monitor a state of the data analyzing unit, based on monitoring time. The monitoring time is a sum of first time that is time required for transferring the operation data to the data analyzing unit and second time that is time required for processing the operation data in the data analyzing unit.

A monitoring method of a data management apparatus according to an embodiment of the present invention includes: processing transferred operation data of a semiconductor manufacturing apparatus by a data analyzing unit included in the data management apparatus; and monitoring a state of the data analyzing unit based on monitoring time. The monitoring time is a sum of first time that is time required for transferring the operation data to the data analyzing unit and second time that is time required for processing the operation data in the data analyzing unit.

In the data management apparatus that manages the data collected in the semiconductor manufacturing apparatus, according to the embodiment of the present invention, even in a case where an application operating in the data management apparatus experiences an unexpected state that cannot be determined from the outside, the state can be grasped.

### BRIEF DESCRIPTION OF THE DRAWINGS

FIG. 1 is a diagram of an embodiment in a case where the present invention has been applied to a plasma processing apparatus in a semiconductor manufacturing line;

FIG. 2 is a sequence diagram of details of state monitoring according to the embodiment of the present invention; and

FIG. 3 is a flow chart of the state monitoring according to the embodiment of the present invention.

### DESCRIPTION OF THE EMBODIMENTS

An embodiment will be described with reference to the drawings below.

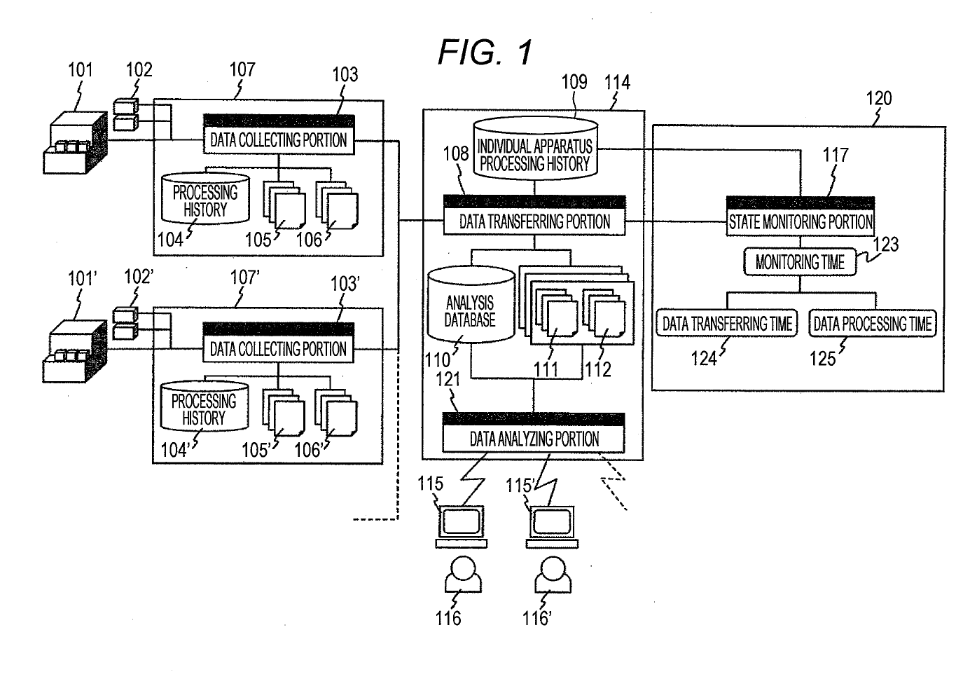

FIG. 1 is a diagram of an embodiment in a case where the present invention has been applied to a plasma processing apparatus in a semiconductor manufacturing line. The plasma processing apparatus 101 includes a data collecting unit 107 that temporarily stores data in the apparatus being operated. A data collecting portion 103 in the data collecting unit 107 collects time series data 105 acquired from various sensors, for example, sensors for electric power values, voltage values, gas flow rate values, and pressure values, disposed at each part relating to apparatus/process control. A storage device included in the data collecting unit 107 stores the time series data 105 in a file format or a database format.

The data collecting portion 103 collects time series data 106 of emission intensity every wavelength collected by an emission spectroscope 102 that monitors plasma emission inside a processing chamber, and stores the time series data 106 in a file format or a database format. The emission spectroscope 102 is added to the plasma processing apparatus 101. Note that a sensor to be added is not limited to the emission spectroscope 102, and may be, for example, a mass spectrometer or a plasma impedance monitor.

The data collecting portion 103 acquires, every processing unit (lot and wafer) processed by the apparatus, information relating to the processing units (for example, a lot name, processing start/end time, a recipe condition (manufacturing condition), and a storage space of each of the pieces of time series data). The data collecting portion 103 stores the information, as a processing history 104, in a file format or a database format.

Note that a plurality of manufacturing apparatuses is present in a semiconductor manufacturing line. According to the present embodiment, a plurality of apparatuses including an apparatus 101′ in addition to the plasma processing apparatus 101 is also present. An emission spectroscope 102′ and a data collecting unit 107′ attached to the apparatus have the same configurations as those attached to the plasma processing apparatus 101. Therefore, a data collecting portion 103′ collects pieces of time series data 105′ and 106′ and a processing history 104′ of the plasma processing apparatus 101′. Note that a sensor classification varies depending on an apparatus. Contents of data to be collected (for example, a data item and a sampling cycle) may also vary.

A data analyzing unit 114 includes a data transferring portion 108 and a data analyzing portion 121, and has also a data sever function together with a data analyzing function. The data transferring portion 108 is coupled to the data collecting portions 103 and 103′ of the plurality of apparatuses, and copies the pieces of data stored in the data collecting units 107 and 107′ of the respective apparatuses, to the data analyzing unit 114 also having a function as a large-capacity storage device. In this case, the processing history 104 and a processing history 104′ each are copied as an individual apparatus processing history 109. The pieces of time series data 105, 106, 105′, and 106′ are copied as pieces of individual apparatus time series data 111 and 112. Note that, some types of data conversion, such as compression from a text format into a binary format, may be performed to the pieces of data that have been copied, in order to secure capacity of the storage device.

The data transferring portion 108 refers to the processing histories of the apparatuses from the individual apparatus processing history 109, and searches for data that has not been stored in the data analyzing unit 114 yet. For example, object data for which the search has been performed, is transmitted to the data transferring portion 108 from the data collecting portion 103, and then is stored in the data analyzing unit 114. The data transferring portion 108 records that the data has been received and stored, in a data field of the individual apparatus processing history 109. Accordingly, data that has not been received and stored, becomes an object when another search is performed next time.

The data transferring portion 108 analyzes the pieces of data that have been copied, constructs analysis information, and stores the analysis information in an analysis database 110. The analysis information includes information of the individual apparatus processing history 109, information of a result of the pieces of individual apparatus time series data 111 and 112 classified in various categories, such as a lot unit and a recipe unit, and information of a result of calculation of basic statistics of, for example, maximum/minimum values, averages, and standard deviations by dividing the pieces of time series data every process step.

In a case where data analysis is performed, there is a need to perform preprocessing (working) to data for individual purposes of analysis by extracting only object data to be analyzed from entire data or by calculating the basic statistics of the pieces of time series data. Thus, time is sometimes required for the preprocessing. Therefore, as described above, the preprocessing expected upon the analysis is previously executed when the data is stored. Then, a result of the preprocessing is stored in the analysis database 110.

When an analysis operation is performed, users 116 and 116′ use analysis terminals 115 and 115′, respectively, so as to access the data analyzing portion 121. The data analyzing portion 121 that has been accessed performs analysis processing requested by the users, referring to the analysis database 110. In this case, as described above, the preprocessing of the analysis previously expected has already been executed in the analysis database 110. Thus, the users 116 and 116′ can dramatically reduce time required for the analysis. As a result, analysis efficiency improves.

The data analyzing portion 121 is opened to a specific range through a communication network. Then, these pieces of data are analyzed so as to be used for, for example, trouble shooting and process improvement of the manufacturing apparatuses operating in the manufacturing line. Therefore, the data stored in the data analyzing unit 114 is extremely important data in terms of manufacturing line management. Accordingly, the data analyzing unit 114 storing the important information is required to continue to operate at all times. A technique, such as an UPS or a RAID that improves redundancy of a hard disk, has been applied for hardware in order to operate at all times. Application of a server OS, and monitoring of a CPU load factor, memory usage, a hard disk activity ratio, and the like, have been performed for software.

Furthermore, operation monitoring of an application process, managed by the server OS is sometimes performed in monitoring of an application operating on the data analyzing unit 114. However, these measures are sometimes not sufficient for the state monitoring of the application. That is, the state of the application is sometimes, barely determined from the outside. Thus, accurate state monitoring cannot be sometimes performed by only monitoring whether the operation has been performed. In particular, in a case where the application that executes, in advance, the preprocessing for the analysis operation is provided in addition to the data transfer/storage, similarly to the data analyzing unit 114 described in the present embodiment, the processing becomes complicated or the load increases. Thus, a possibility that unexpected trouble occurs, increases.

Task monitoring (checking of whether a program has run) of the application process included in the server OS is sometimes performed in monitoring of the application operating on the server. However, this is sometimes insufficient. That is, the state of the application is sometimes, barely determined from the outside. Thus, the accurate state monitoring cannot be sometimes performed by only monitoring whether the operation has been performed.

It cannot be sometimes determined whether the processing is correctly performed in the data transferring portion 108 that operates in the data analyzing unit 114 according to the present embodiment, by only monitoring whether the data transferring portion 108 has operated. Therefore, a state monitoring unit 120 is disposed and a state monitoring portion 117 is operated therein in order to monitor a state of the data transferring portion 108.

The state monitoring portion 117 monitors whether the data transferring portion 108 has correctly operated. The state monitoring portion 117 has a function for performing recovery processing by, for example, resetting the data transferring portion 108 and a function for notifying persons in charge of the apparatuses and systems of an operating state through the communication network in a case where incorrect operation has been determined.

A method of monitoring the data transferring portion 108 by the state monitoring portion 117 will be described. In a unit (individual wafer processing or an individual file) in which the data transferring portion 108 transfers the data from the data collecting portion 103, the state monitoring portion 117 adds data transferring time 124 required for the transfer and data processing time 125 required for performing analysis processing to the transferred data and registering the transferred data in the analysis database 110, together. The result is defined as monitoring time 123. The state monitoring portion 117 communicates with the data transferring portion 108. The data transferring portion 108 monitors whether the data transfer and the data processing of the processing should be completed during the monitoring time.

Next, a method of calculating the data transferring time 124 will be described. The time is required for data transfer from the data collecting unit 107 to the data analyzing unit 114. The time varies, depending on an amount of data to be transferred. Specifically, the amount of data (byte) is calculated by multiplying process processing time (sec) of object data to be transferred, acquired by referring to the individual apparatus processing history 109 by the state monitoring portion 117, by an individual apparatus data collecting amount per unit processing time (byte/sec), previously retained in the state monitoring unit 120. Then, the data transferring time is calculated by dividing the amount of data (byte) by a network transmission speed (byte/sec) between the data collecting portion 103 and the data transferring portion 108, retained in the state monitoring unit 120.

Alternatively, a maximum amount of data collected by the data collecting unit 107, namely, an amount of data (byte) during maximum process time, processed by the plasma processing apparatus 101 is divided by the network transmission speed (byte/sec). Then, the calculated value may be made to be the data transferring time. In this case, the data transferring time becomes constant regardless of the amount of data.

Next, a method of calculating the data processing time 125, will be described. The time is required for analyzing the data that has been transferred, constructing and storing the analysis information in the analysis database 110, by the data transferring portion 108. The time varies, depending on the amount of data that has been transferred. The amount of data (byte) is calculated by multiplying process processing time (sec) of the data, acquired by referring to the individual apparatus processing history 109 by the state monitoring portion 117, by the individual apparatus data collecting amount (byte/sec) per unit processing time, previously retained in the state monitoring unit 120. Then, the data processing time 125 is calculated by dividing the amount of data (byte) by an individual apparatus data processing amount per unit processing time (byte/sec), retained in the state monitoring unit 120.

Alternatively, the maximum amount of data collected by the data collecting unit 107, namely, the amount of data (byte) during the maximum process time, processed by the plasma processing apparatus 101 is divided by an individual apparatus data processing amount (byte/sec) per unit processing time. Then, the calculated value may be made to be the data processing time. In this case, the data processing time becomes constant regardless of the amount of data.

The data transferring time 124 and the data processing time 125 that have been calculated as described above, are added together so as to be defined as the monitoring time 123.

Subsequently, a process of monitoring the data transferring portion 108 by the state monitoring portion 117 will be described.

The data transferring portion 108 notifies the state monitoring portion 117 of information on data to be an object to be transferred, before the data transfer is started. The state monitoring portion 117 acquires processing time of the object data from the individual apparatus processing history 109. Then, the monitoring time 123 is set with the data transferring time 124 and the data processing time 125 calculated by the above method. Note that, an allowable range of, for example, ±50% is set in the monitoring time.

When the data transferring portion 108 notifies the state monitoring portion 117 of a data transfer start, the state monitoring portion 117 performs the monitoring during the monitoring time together with time of the allowable range until receiving notification that the data transfer and registration into the analysis database 110 have been completed, from the data transferring portion 108. In a case where a result of the monitoring is out of a range of the monitoring time including the allowable range, the state monitoring portion 117 determines that the data transferring portion 108 has been abnormal. The state monitoring portion 117 stops and reboots the data transferring portion 108 so as to perform the recovery processing. Alternatively, for example, the apparatus users and the person in charge of the manufacturing line are notified of the result through the communication network so as to be prompted to restore the data transferring portion 108.

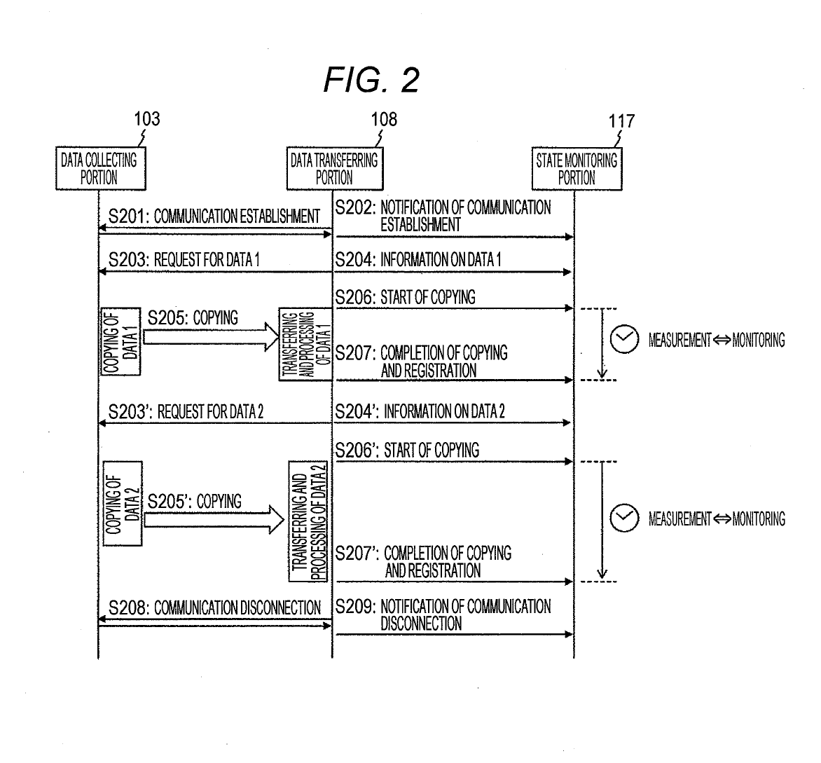

FIG. 2 is a sequence diagram of details of the state monitoring of the data management apparatus in FIG. 1. A process of the state monitoring will be described below in accordance with the sequence diagram.

At S201, the data transferring portion 108 establishes a communication state with the data collecting portion 103. At S202, the data transferring portion 108 notifies the state monitoring portion 117 that the communication state of the data transfer has been established. Then, state monitoring processing of the state monitoring portion 117 starts. At S203, the data transferring portion 108 searches for data that has not been stored from the processing history 104 into the data analyzing unit 114 yet, and requests the data collecting portion 103 to perform the data transfer of the data for which the search has been performed. Here, the data for which the search has been performed is defined as data 1.

At S204, the data transferring portion 108 notifies the state monitoring portion 117 of information on the data 1, simultaneously with S203. The state monitoring portion 117 acquires process processing time of the data 1 from the information from the individual apparatus processing history 109. Furthermore, with the above method, the data transferring time 124 and the data processing time 125 are calculated and then are added together so as to be defined as monitoring time of the “data 1”. At S205, the data transfer is started between the data collecting portion 103 and the data transferring portion 108 for the “data 1” as an object. At S206, the data transferring portion 108 notifies the state monitoring portion 117 that the data transfer of the “data 1” has been started, simultaneously with S205. The state monitoring portion 117 starts time measurement from this point.

At S207, the data transferring portion 108 notifies the state monitoring portion 117 that the data transfer and the data processing of the “data 1” have been completed. The state monitoring portion 117 completes the time measurement at this point. The measured time and the monitoring time including the allowable range are compared. Then, it is determined whether the data transfer and the data processing of the “data 1” have been correctly completed. In a case where the state monitoring portion 117 determines that the data transferring portion 108 has been in an abnormal state, the state monitoring portion 117 notifies the apparatus users and the person in charge of the manufacturing line of whether the recovery processing is performed by the reboot of the data transferring portion 108.

At S203′, in a case where data to be a next data transfer candidate is present, the data transferring portion 108 requests the data collecting portion 103 to perform data transfer of the next data. Here, the next data is defined as “data 2”. At S204′, the data transferring portion 108 notifies the state monitoring portion 117 of information on the “data 2”, simultaneously with S203′. The state monitoring portion 117 acquires process processing time of the “data 2” from the information from the individual apparatus processing history 109. Furthermore, with the above method, the data transferring time 124 and the data processing time 125 are calculated, and then are added together so as to be defined as monitoring time of the “data 2”.

At S205′, the data transfer is started between the data collecting portion 103 and the data transferring portion 108 for the “data 2” as an object. At S206′, the data transferring portion 108 notifies the state monitoring portion 117 that the data transfer of the “data 2” has been started, simultaneously with S205′. The state monitoring portion 117 starts time measurement from this point.

At S207′, the data transferring portion 108 notifies the state monitoring portion 117 that the data transfer and the data processing of the “data 2” have been completed. The state monitoring portion 117 completes the time measurement at this point. The measured time and the monitoring time including the allowable range are compared. Then, it is determined whether the data transfer and the data processing of the “data 2” have been correctly completed. In a case where the state monitoring portion 117 determines that the data transferring portion 108 has been in an abnormal state, the state monitoring portion 117 notifies the apparatus users and the person in charge of the manufacturing line of whether the recovery processing is performed by the reboot of the data transferring portion 108.

At S208, in a case where target data to be transferred is not present, the data transferring portion 108 disconnects the communication with the data collecting portion 103. At S209, the data transferring portion 108 notifies the state monitoring portion 117 that the communication has been disconnected. Then, the state monitoring processing of the state monitoring portion 117 is completed.

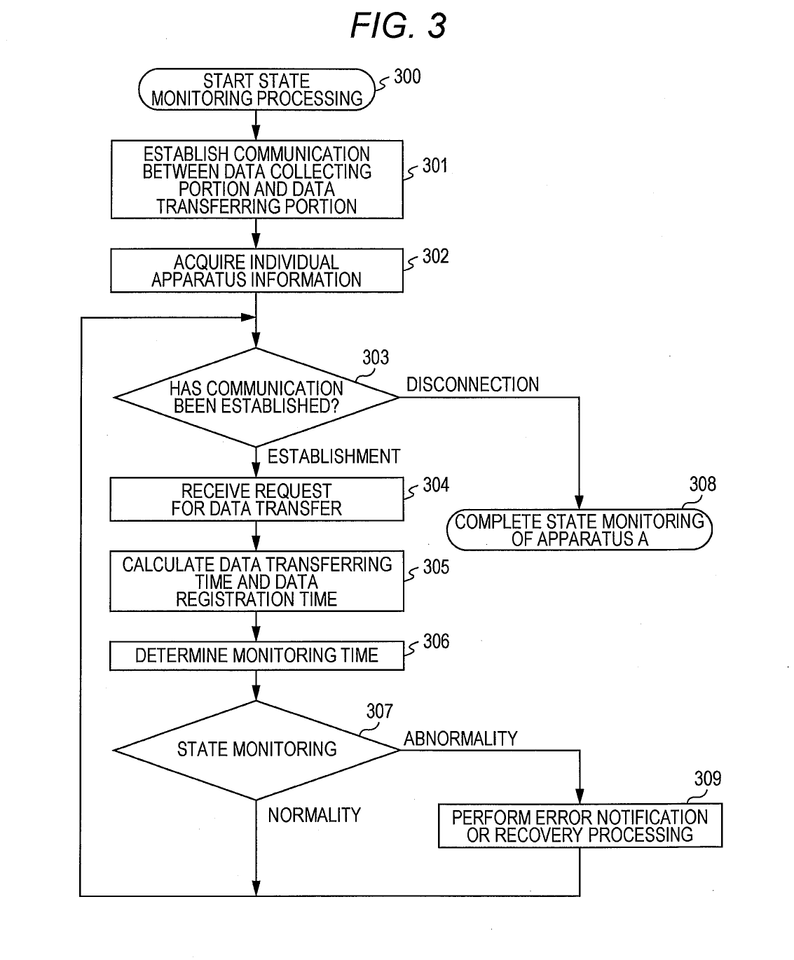

FIG. 3 is a flow chart of the state monitoring according to the embodiment of the present invention. Operation based on this is as follows:

At step 300, the state monitoring portion 117 illustrated in FIG. 1 starts the state monitoring processing of the data transferring portion 108. At step 301, the data transferring portion 108 notifies the state monitoring portion 117 that the communication state with the data collecting portion 103 has been established. The state monitoring portion 117 that has received the notification, starts the state monitoring processing. At step 302, the state monitoring portion 117 acquires and retains the data collecting amount per unit processing time (byte/sec), the network transmission speed (byte/sec), and the data processing amount per unit processing time (byte/sec) of the individual apparatus coupled to the data collecting portion 103, selected as objects by the data transferring portion 108.

At step 303, the state monitoring portion 117 checks whether the data transferring portion 108 has established communication with the data collecting portion 103, that performs the data transfer. When the communication has been disconnected, the processing proceeds to step 308. At step 304, the data transferring portion 108 requests the data collecting portion 103 to perform the data transfer of the data. Simultaneously, the data transferring portion 108 notifies the state monitoring portion 117 that the request has been made. In this case, the data transferring portion 108 simultaneously notifies the state monitoring portion 117 of identifying information of the data. This information is unique key information for searching for detailed processing contents of the data (for example, processing time and a recipe), from the individual apparatus processing history 109.

At step 305, the state monitoring portion 117 calculates the data transferring time 124 required for transferring the data and the data processing time 125 required for the registration in the analysis database 110, based on the pieces of information acquired at step 302 and step 304. The data transferring time 124 and the data processing time 125 calculated at step 305 are added together at step 306. Furthermore, the allowable range is set to the numerical value. For example, −50% of estimated time and +50% of the estimated time are set as a lower limit and an upper limit, respectively. The numerical value including this allowable range is defined as the monitoring time 123 of the data.

At step 307, the notification of the data transfer start of the data is received from the data transferring portion 108. With the monitoring time set at step 306, the state monitoring is performed until notification of the completion of the data transfer and the data processing is received. In a case where normality is determined, the processing proceeds to step 303. In a case where abnormality is determined, the processing proceeds to step 309. At step 308, the state monitoring portion 117 completes the state monitoring of the data collecting portion 103 and the data transferring portion 108.

At step 309, since it is determined that the data transferring portion 108 has been in an abnormal state, the state monitoring portion 117 notifies the apparatus users and the person in charge of the manufacturing line of a content of whether the recovery processing is performed by the reboot of the data transferring portion 108.

As described above, according to the embodiment of the present invention, in the data management apparatus that manages the data collected by each of the semiconductor manufacturing apparatuses, even in a case where the application operating in the data management apparatus experiences an unexpected state that cannot be determined from the outside, the state can be grasped and the recovery processing and the error notification can be promptly performed.

1. A data management apparatus comprising:
a data analyzing unit configured to process operation data transferred from a data collecting unit that collects the operation data of a semiconductor manufacturing apparatus; and
a state monitoring unit configured to monitor a state of the data analyzing unit, based on monitoring time,
wherein the monitoring time is a sum of first time that is time required for transferring the operation data to the data analyzing unit and second time that is time required for processing the operation data in the data analyzing unit.

2. The data management apparatus according to claim 1, wherein the monitoring time is time acquired based on a maximum value of the first time and a maximum value of the second time.

3. The data management apparatus according to claim 1, wherein the monitoring time is acquired every manufacturing condition of the semiconductor manufacturing apparatus.

4. The data management apparatus according to claim 1, wherein the state monitoring unit restores the data analyzing unit by resetting the data analyzing unit in a case where the state monitoring unit determines that a state of the data analyzing unit is abnormal.

5. The data management apparatus according to claim 1, wherein the data analyzing apparatus is coupled to the plurality of semiconductor manufacturing apparatuses through a communication network.

6. A monitoring method of a data management apparatus comprising:
processing transferred operation data of a semiconductor manufacturing apparatus by a data analyzing unit included in the data management apparatus; and
monitoring a state of the data analyzing unit based on monitoring time,
wherein the monitoring time is a sum of first time that is time required for transferring the operation data to the data analyzing unit and second time that is time required for processing the operation data in the data analyzing unit.
